(19) United States
(12) Patent Application Publication
(10) Pub. No.: US 2026/0025562 A1
(43) Pub. Date: Jan. 22, 2026

(54) Sport Vehicle Video System

(71) Applicant: WhitServe LLC, Stamford, CT (US)

(72) Inventors: Wesley W. Whitmyer, Jr., Stamford, CT (US); Declan W. Whitmyer, Stamford, CT (US)

(21) Appl. No.: 19/276,877

(22) Filed: Jul. 22, 2025

Related U.S. Application Data
(60) Provisional application No. 63/673,904, filed on Jul. 22, 2024.

(51) Int. Cl. H04N 23/45; H04N 7/18

(52) U.S. Cl. CPC H04N 23/45; H04N 7/181

(57) ABSTRACT

A system for sport vehicle video includes a sport vehicle; a video of an operator controlling the sport vehicle; a smartphone mounted to the sport vehicle, the smartphone for sensing and displaying performance data to the operator of the sport vehicle; a screen recording of the performance data displayed to the operator on the smartphone; and a composite video of the performance data screen recording overlaid on the sport vehicle video.

### TECHNICAL FIELD

The present application relates to video systems. In particular, the present application relates to sport vehicle video systems.

### BACKGROUND

Sport vehicles of all types, from bicycles and motorcycles to sailboats and motorboats, to skis, surfboards, hang gliders and beyond provide a unique opportunity for people to obtain videos of themselves enjoying their sport. GoPro® cameras can be mounted to record both experience-type videos and selfie-type videos. Memory cards or cables are typically used to remove video from the camera for editing and reviewing on a laptop computer.

Smartphones can also be used to take videos of sporting activities, and many people mount their smartphone to their vehicles for exactly this purpose. An advantage of smartphone video is that it is already on a computing device with editing and communication features. Sharing smartphone videos of this type is the foundation of social media.

Separately, smartphones used with or mounted on sport vehicles are commonly used to collect and display performance data about the sport vehicle. For example, apps exist that display speed and heading of the vehicle and other more esoteric information as might be useful or interesting to the operator. In a sailboat, apps such as Lights Out Sailing® display data sensed by the smartphone itself such as speed over ground, heading, heel and the like, while other apps display data transmitted from external sensors which measure things like wind speed, speed through the water, rig tension, and the like. Frequently, these data are used by sport vehicle operators in real time to improve performance either in training or competition settings.

More recently, companies such as Njord Analytics® have built a video processing engine that will overlay performance data on sport vehicle video. This is a slow and relatively expensive process which requires offloading the video from the camera to a laptop, then uploading the video into the application, doing the same with any logged data that is desired to be overlaid, then reprocessing the video into a new file for viewing in an application.

This process is very time-and computer power-intensive. It can only be done at the end of the day once you are off the sport vehicle and can pull out your laptop computer. Another disadvantage is that there is no way to know if the overlaid data was even viewed by the sport vehicle operator at the time the video was made. In sailboat racing, teams often have one or more team members dedicated to the data-crunching role.

### SUMMARY

The invention provides the advantages of overlaying performance data on sport vehicle videos, while reducing the time and cost needed to generate such output for use by operators in training and competition.

Accordingly, a sport vehicle video system is provided which generates a composite video which overlays performance data displayed on a smartphone during operation of the sport vehicle with video taken by the same smartphone. The video may be provided in selfie or experience mode. The performance data is captured by screen recording the smartphone when the smartphone is recording video. And the overlay is relatively easy to process as a small version of the smartphone screen overlaying a corner of a full screen replay of the smartphone video.

The invention significantly reduces the time and cost of providing training tools previously only available at high cost to the biggest professional sport vehicle teams. If the composite is made on the same smartphone as the video and screen recording, teams could literally review the composite video between races. Simply matching the screen record and the vehicle video all “logged” data is automatically time synced. And the data shown in the composite is exactly the data available and displayed to the operator during making of the video.

### BRIEF DESCRIPTION OF THE DRAWINGS

FIG. 1 depicts a system according to one embodiment of the present disclosure, including the relationship between steps or processes of the same system.

FIG. 2 shows an exemplary composite video created using the system embodied in FIG. 1.

### DETAILED DESCRIPTION

The present teachings are described more fully hereinafter with reference to the accompanying drawings. The following description is presented for illustrative purposes only and the present teachings should not be limited to these embodiments.

In compliance with the statute, the present teachings have been described in language more or less specific as to structural features. It is to be understood, however, that the present teachings are not limited to the specific features shown and described, since the systems herein disclosed comprise preferred forms of putting the present teachings into effect.

Generally, all terms used in the claims are to be interpreted according to their ordinary meaning in the technical field, unless explicitly defined otherwise herein. All references to a/an/the element, apparatus, component, means, step, etc., are to be interpreted openly as referring to at least one instance of the element, apparatus, component, means, step, etc., unless explicitly stated otherwise. The steps of any method disclosed herein do not have to be performed in the exact order disclosed, unless explicitly stated. The use of “first”, “second,” etc., for different features/components of the present disclosure are only intended to distinguish the features/components from other similar features/components and not to impart any order or hierarchy to the features/components.

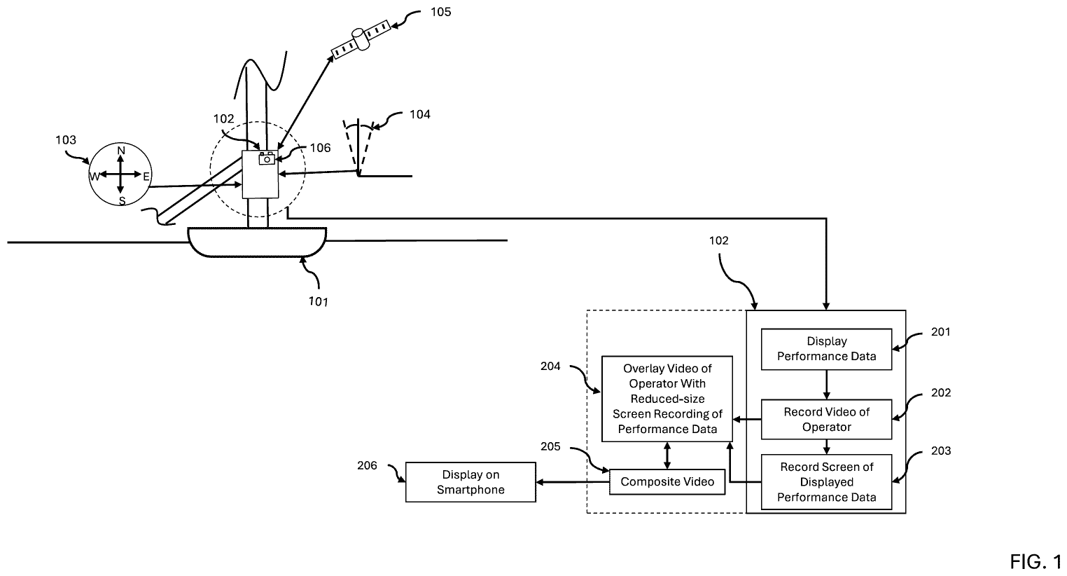

FIG. 1 presents one view of a system according to the present teachings. FIG. 1 includes a sport vehicle 101 (shown as a sailboat), a smartphone 102, various performance indicia 103 (shown as the navigational direction of the sport vehicle 101), 104 (shown as the heel angle of the sport vehicle 101), a connection between the smartphone 102 and a network 105 (shown as a satellite), and a camera (106).

The sport vehicle 101 is shown as a sailboat in FIG. 1. However, the sport vehicle 101 may be, without limitation, any vehicle known in the art for sporting purposes. Examples include bicycles, motorcycles, motorboats, skis, surfboards, hang gliders, paragliders, and paddleboards. All that is necessary is that the sport vehicle 101 be operable by a user. The sport vehicle 101 may be physically operated by a user or operated remotely. However, it is preferred that the sport vehicle 101 be physically operated by a user.

A smartphone 102 is shown in FIG. 1. The smartphone 102 may be any type of smartphone known in the art. In some embodiments, the smartphone 102 may be a tablet or other portable computing device. When in use, the smartphone 102 may be mounted to the sport vehicle 101 directly or set in place using a mount (not shown). In some embodiments, when in use, the smartphone 102 will be rigidly set in place. In other embodiments, when in use, the smartphone 102 may be held by a user (not shown).

The smartphone 102 should be capable of displaying various performance indicia. FIG. 1 presents two exemplary indicia 103, 104. The performance indicator 103 is the direction of the sport vehicle 101. The performance indicator 104 is the heel direction of the sport vehicle 101. While these indicia 103, 104 are exemplary with respect to the sport vehicle 101 being a sailboat, other indicia are within the scope of the present disclosure. For example, other performance indicia may include, without limitation, speed, tire pressure, and tiller direction. In some embodiments, performance indicia may be relevant only for a particular sport vehicle 101.

To display the one or more performance indicia, the smartphone 102 should be in communication with one or more sensors (not shown) to produce the performance indicia data. The one or more sensors may be mounted to the smartphone 102 itself, or they may be peripheral devices or a combination thereof.

The smartphone 102 may be in communication with a camera 106. The camera 106 may be mounted on the smartphone 102 or may be a peripheral device. The camera 106 should be capable of recording video footage. In some embodiments, the camera 106 may record video in selfie mode (i.e., in the direction of an operator of the smartphone 102), while in other embodiments, the camera 106 may record video in experience mode (i.e., in the direction opposite of an operator of the smartphone 102). In any event, the smartphone should be capable of displaying the footage taken by the camera 106. It is preferred that the smartphone 102 be capable of displaying the footage taken by the camera 106 in real time (i.e., with zero latency) or with as little latency as possible.

In some embodiments, the smartphone 102 may be in communication with a network 105 (shown as a satellite) for purposes of transmitting and/or receiving data. For example, if the smartphone 102 is in electronic communication with a network 105, it may be possible to transmit the composite video of the performance indicia with the footage taken by the camera 106 in real time to a user who may not be operating the sport vehicle 101 (e.g., a team member who performs a data-crunching role). Other purposes are also envisioned where the smartphone 102 is in communication with a network 105, including for the purpose of transmitting course data or messages from a third party (e.g., a race control official) to the smartphone 102.

FIG. 1 also presents the relationship between the steps or processes of a smartphone 102 according to one embodiment of the present teachings. These processes are understood to take place within the smartphone 102.

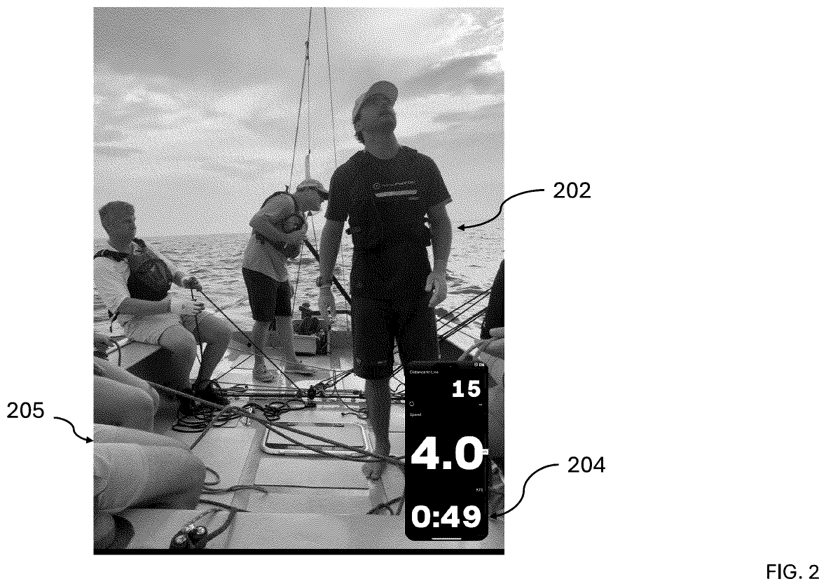

A prominent feature of the present technology is that performance data be displayed 201 on the smartphone 102. The performance data can be exemplary indicia 103, 104, or any other sort of relevant performance indicia as previously described. It is envisioned that the performance data are displayed on the smartphone 102 in a manner that is viewable to an operator in real time, such as in the corner of the smartphone 102 screen (as seen in FIG. 2).

With the performance data displayed on the smartphone 102, the camera 106 should begin recording footage of the sport vehicle 101 in operation. These processes can occur in that order or vice versa. The video footage taken by the camera 106 should be displayed on the smartphone 102, ideally in real time. With the performance data overlaid on the smartphone 102 screen while said smartphone 102 screen displays the performance data, a composite 205 is created on the smartphone.

The next process is to record the screen of the smartphone 102 while both the performance data and the camera footage are simultaneously displayed. This step records the composite 205 video created on the smartphone 102, which may be useful for later playing and analyzing. By recording the screen 203 of the smartphone 102 at this stage, an operator effectively syncs the performance data 201 with the video 202 taken by the camera 106. This synced composite video 205 is displayed 206 on the smartphone 102.

What is claimed is:

1. A sport vehicle video system, comprising:
a sport vehicle;
a video of an operator controlling said sport vehicle;
a smartphone mounted to said sport vehicle, said smartphone for sensing and displaying performance data to the operator of said sport vehicle;
a screen recording of the performance data displayed to the operator on said smartphone; and
a composite video of said performance data screen recording overlaid on said sport vehicle video.

2. The sport vehicle video system of claim 1, wherein said sport vehicle video is taken with said smartphone.

3. The sport vehicle video system of claim 1, wherein said composite video is made on said smartphone.

4. The sport vehicle video system of claim 1, wherein said composite video is displayed on said smartphone.

5. The sport vehicle video system of claim 1, wherein said smartphone takes a selfie video of the operator, and wherein said selfie video is added as a third component to said composite video.

6. The sport vehicle video system of claim 1, wherein said sport vehicle video is an onboard video of the sport vehicle.

7. The sport vehicle video system of claim 1, wherein said sport vehicle video is a selfie video of the operator of the sport vehicle.
